(19) United States
(12) Patent Application Publication
(10) Pub. No.: US 2010/0162351 A1
(43) Pub. Date: Jun. 24, 2010

(54) SYSTEM AND METHOD FOR DOCUMENT ACCESS MANAGEMENT

(75) Inventors: CHUNG-I LEE, Tu-Cheng (TW); XIN-YU HUANG, Shenzhen City (CN); DONG-WEI JIN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/579,498

(22) Filed: Oct. 15, 2009

(30) Foreign Application Priority Data
Dec. 19, 2008 (CN) 200810306396.7

(51) Int. Cl. G06F 17/00; H04L 9/32; G06F 21/00

(52) U.S. Cl. 726/1; 715/255; 726/28

(57) ABSTRACT

In a system for document access management, each page of the electronic document is converted into an image, and viewing and download permission to view and download each converted image are set. The page of the electronic document is further converted into a restricted image comprising only designated elements.

### BACKGROUND

1. Technical Field

Embodiments of the present disclosure relate to electronic document management, and particularly to a system and method for document access management.

2. Description of Related Art

With the growth in sensitive information stored in computers or transmitted over networks, the need for ensuring the security of information has risen multifold. For example, there may be electronic documents in computers that are strictly confidential. Therefore, it has become essential that the information should be secured.

### BRIEF DESCRIPTION OF THE DRAWINGS

FIG. 1 is a block diagram of a computer utilizing one embodiment of a document access management system.

FIG. 2 is a block diagram of the document access management system in FIG. 1.

FIG. 3 is a schematic diagram of one embodiment of a restricted image.

FIG. 4 is a flowchart of one embodiment of a method for document access management.

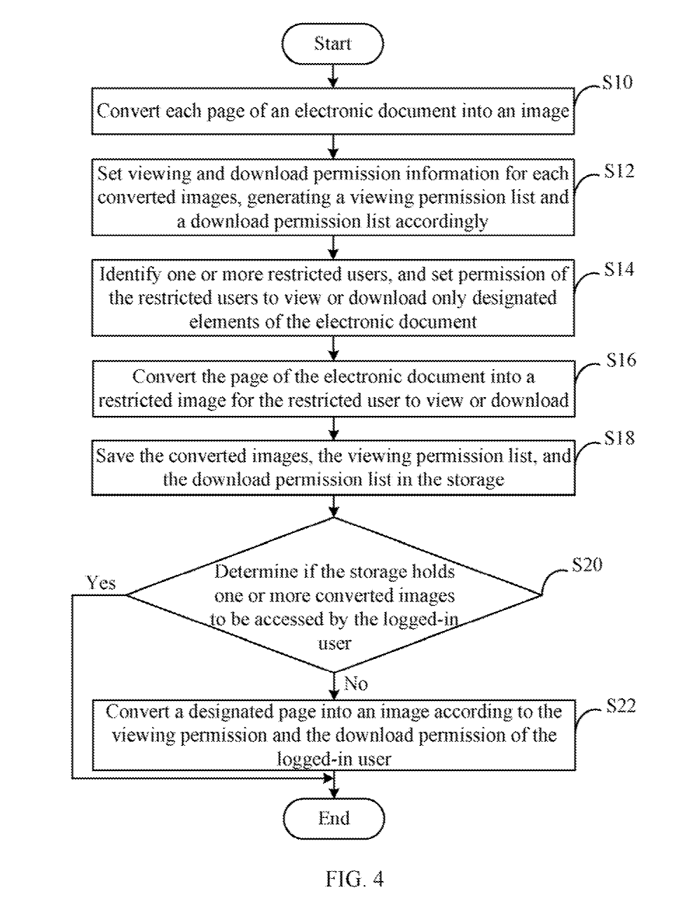

### DETAILED DESCRIPTION

All of the processes described may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

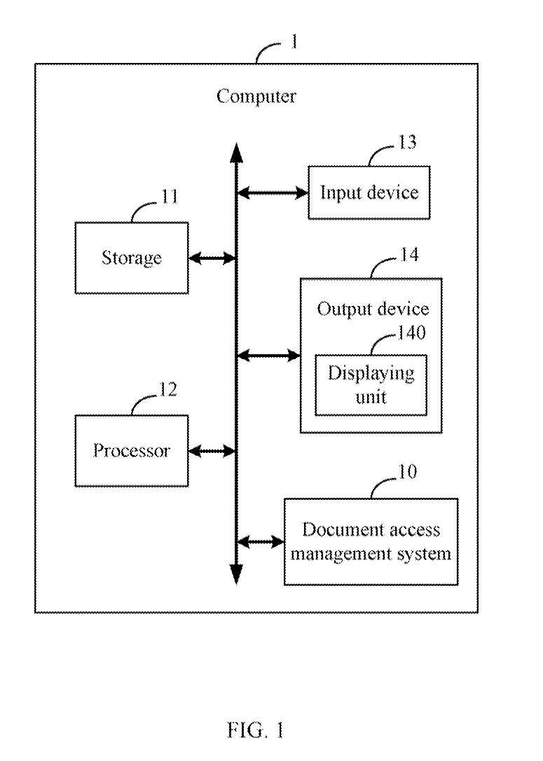

FIG. 1 is a block diagram of a computer 1 utilizing one embodiment of a document access management system 10. The document access management system 10 may be used to convert each page of an electronic document into an image, and manage viewing and download permissions for each converted image.

The computer 1 also includes a storage 11, a processor 12, an input device 13, and an output device 14. The processor 12 executes one or more computerized operations of the computer 1 and other applications, to provide the functions of the computer 1. The storage 11 stores one or more programs, such as programs of an operating system, other applications of the computer 1, and various data, such as the electronic document, for example. In one embodiment, the storage 11 may be a memory of the computer 1, such as a hard disk, or an external storage card, such as a flash card.

The input device 13 receives input data, such as the viewing permission and download permission of converted images, for users to view converted image and download the converted images. The input device 13 may be a keyboard, a mouse, or other input device.

In one embodiment, the output device 14 includes a display 140 allowing the converted images to be viewed.

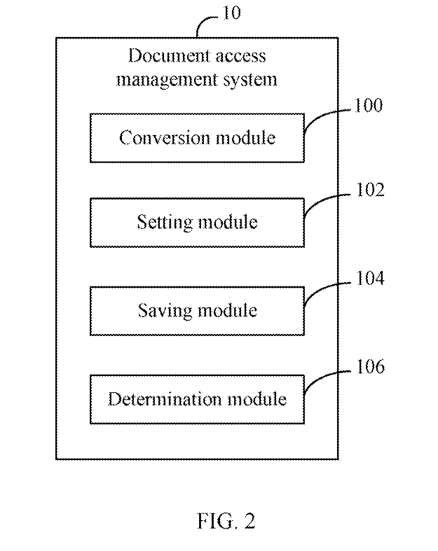

FIG. 2 is a block diagram of one embodiment of the document access management system 10 in FIG. 1. In one embodiment, the document access management system 10 includes a conversion module 100, a setting module 102, a saving module 104, and a determination module 106. The modules 100, 102, 104, and 106 may comprise one or more computerized operations to be executed by the processor 12 to perform one or more operations of the computer 1. Details of these operations follow.

The conversion module 100 converts each page of the electronic document into an image. For example, an electronic document may include first, second, and third pages. The conversion module 100 converts the first page of the electronic document into a first image, converts the second page of the electronic document into a second image, converts the third page of the electronic document into a third image. The electronic document format may be, for example .DOC, and the image format .JPG., but the disclosure is not limited thereto.

The setting module 102 sets viewing permissions and download permissions for users to view converted image and download converted images, and generates a viewing permission list including viewing permissions and a download permission list including download permissions for the converted images. The setting module 102 sets permissions for each user according to the pages permissible for the user to view or download.

The setting module 102 may also be used to identify restricted users who have the permission to view or download only designated elements of a page of the electronic document. The status and permission for such restricted users appear in the viewing and download permission list.

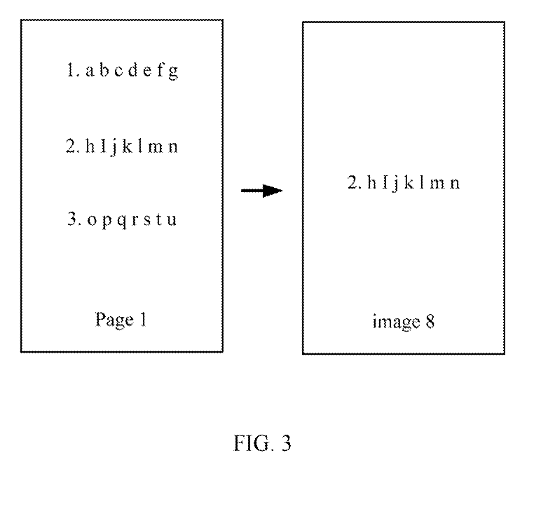

The conversion module 100 converts the page of the electronic document into a restricted image for the restricted user to view or download. The restricted image merely includes the designated elements. As shown in FIG. 3, a restricted image 8 merely includes element 2 of a first page of the electronic document.

The saving module 104 saves the converted images and permission list in the storage 11.

The determination module 106 identifies permissions for every user logging onto the computer 1, and seeks any converted images for which the logged-in user has permission of any type. If the storage 11 holds converted images for which the logged-in user has permission to view and download the converted images, the conversion module 100 converts a designated page of the electronic document into an image according to the viewing permission and the download permission of the logged-in user.

FIG. 3 is a flowchart of one embodiment of a method for document access management. Depending on the embodiment, additional blocks may be added, others removed, and the ordering of the blocks may be changed.

In block S10, the conversion module 100 converts pages of the electronic document into images, one image per original page. The document format may be .DOC, and the image format .JPG.

In block S12, the setting module 102 sets viewing permissions and download permissions for users to view converted image and download converted images, and generates a viewing permission list including viewing permissions and a download permission list including download permissions for the converted images.

In block S14, the setting module 102 may further identify one or more restricted users, and set permission of the restricted users to view or download only designated elements of the electronic document. The restricted permission of the restricted users is included in the viewing permission list and the download permission list.

In block S16, the conversion module 100 converts the page of the electronic document into a restricted image for the restricted user to view or download. The restricted image merely includes the designated elements. As shown in FIG. 3, a restricted image 8 merely includes element 2 of a first page of the electronic document.

In block S18, the saving module 104 saves the converted images, the viewing permission list, and the download permission list in the storage 11.

In block S20, the determination module 106 locates the viewing permission and the download permission for a logged in user of the computer 1, and determines if the storage 11 holds one or more converted images to be accessed by the logged-in user.

In block S22, if the storage 11 holds no converted images for the logged-in user, the conversion module 100 converts a designated page of the electronic document into an image according to the viewing permission and the download permission of the logged-in user.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for document access management, the system comprising:
a storage to store an electronic document;
at least one processor; and
one or more programs stored in the storage and executable by the at least one processor, the one or more programs comprising:
a conversion module operable to convert each page of the electronic document into an image;
a setting module operable to set viewing and download permissions for the converted images, and generate a viewing permission list comprising viewing permissions and a download permission list comprising download permissions for the converted images; and
a saving module operable to store the converted images, the viewing permission list and the download permission list in the storage of the computer.

2. The system as claimed in claim 1, wherein the setting module is further operable to identify restricted users of the electronic document, and set corresponding restricted permissions allowing the identified restricted users to view or download only designated elements of each page of the electronic document.

3. The system as claimed in claim 2, wherein the conversion module is further operable to convert the each of the pages of the electronic document into a restricted image comprising only the designated elements.

4. The system as claimed in claim 1, wherein the one or more programs further comprise a determination module operable to locate viewing and download permission for a logged-in user of the system, and determine if the storage holds any converted images that allow to be viewed and/or downloaded by the logged-in user.

5. The system as claimed in claim 4, wherein the conversion module is further operable to convert a designated page of the electronic document into an image according to the viewing permission and the download permission of the logged-in user, if the storage does not have one or more converted images that allow to be viewed and/or downloaded by the logged-in user.

6. The system as claimed in claim 1, wherein the electronic document is a .DOC file, and the converted image a .JPG. file.

7. A computer-implemented method for document access management, the method comprising:
converting each page of the electronic document into an image;
setting viewing and download permissions for the converted images;
generating a viewing permission list comprising viewing permissions and a download permission list comprising viewing permissions for the converted images; and
saving the converted images, the viewing permission list and the download permission list in a storage of the computer.

8. The method of claim 7, further comprising:
identifying one or more restricted users of the electronic document;
setting restricted permissions for the restricted users, allowing viewing or download of only designated elements of each page of the electronic document; and
converting each of the pages of the electronic document to a restricted image, the restricted image merely comprising the designated elements.

9. The method of claim 7, further comprising:
identifying the viewing permission and the download permission of a logged-in user of the system on the computer;
determining if the storage has one or more converted images that allow to be viewed and/or downloaded by the logged-in user.

10. The method of claim 9, further comprising:
converting a designated page of the electronic document into an image according to the viewing permission and the download permission of the logged-in user, if the storage does not have one or more converted images to be viewed and/or downloaded by the logged-in user.

11. The method of claim 7, wherein the electronic document is a .DOC file, and the converted image is a .JPG file.

12. A computer-readable medium having stored thereon instructions that, when executed by a computerized device, cause the computerized device to execute a computer-implemented method for document access management, the method comprising:
converting each page of the electronic document into an image;
setting viewing and download permissions for the converted images;
generating a viewing permission list comprising viewing permissions and a download permission list comprising viewing permissions for the converted images; and
saving the converted images, the viewing permission list and the download permission list in a storage of the computer.

13. The medium of claim 12, further comprising:
identifying one or more restricted users of the electronic document;
setting restricted permissions for the restricted users, allowing viewing or download of only designated elements of each page of the electronic document; and
converting each of the pages of the electronic document to a restricted image, the restricted image merely comprising the designated elements.

14. The medium of claim 12, further comprising:
identifying the viewing permission and the download permission of a logged-in user of the system on the computer;
determining if the storage has one or more converted images that allow to be viewed and/or downloaded by the logged-in user.

15. The medium of claim 14, further comprising:
converting a designated page of the electronic document into an image according to the viewing permission and the download permission of the logged-in user, if the storage does not have one or more converted images that allow to be viewed and/or downloaded by the logged-in user.

16. The medium of claim 12, wherein the electronic document is a .DOC file, and the converted image a .JPG file.
